(19) United States
(12) Patent Application Publication
(10) Pub. No.: US 2005/0082972 A1
(43) Pub. Date: Apr. 21, 2005

(54) Package of organic electro-luminance panel and the manufacturing method thereof

(76) Inventors: Lai-Cheng Chen, HSINCHU (TW); Chun-Hui Tsai, HSINCHU (TW); Sheng-Fu Horng, HSINCHU (TW); Hsin-Fei Meng, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,649

(22) Filed: Dec. 30, 2003

(30) Foreign Application Priority Data
Oct. 17, 2003 (TW) 92128825

(51) Int. Cl. H05B 33/04

(52) U.S. Cl. 313/512; 313/506

(57) ABSTRACT

A package of an organic electro-luminance display panel and a manufacturing method thereof are disclosed. First, an organic electro-luminance display panel with a plurality of first contacts is provided. Then, a cover plate is disposed above the organic electro-luminance display panel, wherein the cover plate has a control circuit and a plurality of second contacts. The second contacts are electrically connected to the first contacts of the organic electro-luminance display panel so that the organic electro-luminance display panel can be controlled by the control circuit. Finally, a frame is formed between the organic electro-luminance display panel and the cover plate. The package of the organic electro-luminance display panel provides a larger display area and a better resolution.

### CROSS REFERENCE TO RELATED APPLICATIONS

This application claims the priority benefit of Taiwan application serial no. 92128825, filed on Oct. 17, 2003.

### BACKGROUND OF INVENTION

1. Field of the Invention

The present invention relates to a package of an organic electro-luminance display panel and a manufacturing method thereof, and more particularly to a package of an organic electro-luminance display panel integrating a control circuit on a cover plate and a manufacturing method thereof.

2. Description of the Related Art

With the rapid advancement of technology, a variety of computers, cellular phones, PDA, digital cameras, etc. have been developed. In these electronic products, displays are very essential. Because of their small size, lightness and low power consumption, flat display panels have been widely used. In flat display panels, organic electro-luminance display panels have wide view angle, high contrast ratio, lower weight, high responsive speed and low costs, and are adapted to be used in electronic clocks, cellular phones, PDA, digital cameras, etc.

An organic electro-luminance (OEL) device includes two electrodes and a luminescent layer between the electrodes. When a voltage is applied to the device, holes from the anode will recombine with electrons from the cathode within the emitting layer; therefore, excitons are generated therein. When the excitons release energy and come back to the ground state, a portion of energy generated therefrom will be released in the form light. This luminescent principle is applied in the organic electro-luminance devices.

It should be noted that the organic electro-luminance display panels initially were passive-drive. Because the luminescence and service life of the passive driving devices will decay with the increasing size and resolution of the display, and therefore active-drive organic electro-luminance display panels are developed.

Referring to FIG. 1, it is a schematic drawing showing a prior art package of an organic electro-luminance display panel. The organic electro-luminance device 110 is, for example, disposed on a glass substrate 120. The organic electro-luminance device 110 comprises an anode layer 112, an organic functional layer 114 and a cathode layer 116, wherein the anode layer 112 is formed on the glass substrate 120 and can be, for example, a transparent electrode comprised of indium tin oxide (ITO). The organic functional layers 114 are formed on the anode layer 112 and includes a hole injection layer, a hole transport layer, an organic luminescent layer, an electron transport layer and an electron injection layer. The cathode layer 116 is formed on the organic functional layer 114. A metal cover plate 130 is disposed over the organic electro-luminance device 110 and attached to the glass substrate 120 via an adhesive 140. The anode layer 112 and cathode layer 116 are exposed for electrically connecting with external circuits.

Referring to FIG. 1, a flexible circuit board 150 having a control circuit is disposed on another side of the glass substrate 120 with respect to the organic electro-luminance device 110. The flexible circuit board 150 comprises a plurality of driving devices 160 and electrically connects to the anode layer 112 and the cathode layer 116 via anisotropic conductive plate (ACP) 170, wherein the connection of the flexible circuit board 150 and the cathode layer 116 is not shown. Therefore, control signals can be inputted to the organic electro-luminance device 110 via the circuit board for controlling the luminescence of the organic electro-luminance device 110. In order to prevent corrosion caused by moisture, getter 132 having desiccant is disposed on the metal cover plate 130 for maintaining the normal operation of the organic electro-luminance device 110 and service life thereof.

However, the prior art package of an organic electro-luminance display panel needs the additional flexible circuit board for carrying driving devices. The thickness of the package of an organic electro-luminance display panel will increase and additional process time is required for packaging the driving devices and the circuit board. Therefore, manufacturing cost and process time is substantially increased.

Moreover, the driving devices and the control circuit can be formed on the glass substrate. For example, in an active-drive package of an organic electro-luminance display panel, an organic luminescent layer and a cathode layer are formed on a thin film transistor array substrate, wherein the organic electro-luminance device are controlled via the thin film transistors. Although no circuit board is required in the active-drive package of an organic electro-luminance display panel, the thickness of the display is reduced. Because the disposition of the thin film transistors, control circuit and the other driving devices form a non-luminescent area of the glass substrate, the display area of the organic electro-luminance display panel is reduced and the resolution of the organic electro-luminance display panel is limited.

### SUMMARY OF INVENTION

An object of the present invention is to provide a package of an organic electro-luminance display panel, having a control circuit over a cover plate for serving a larger display area and improving the resolution of the larger display.

Another object of the present invention is to provide a method of forming a package of an organic electro-luminance display panel, having a control circuit over a cover plate for serving a larger display area and improving the resolution of the larger display.

In accordance with the objects described above, the present invention provides a package of an organic electro-luminance display panel, which comprises an organic electro-luminance display panel, a cover plate and a frame. The cover plate is disposed on the organic electro-luminance display panel and the frame is disposed between the organic electro-luminance display panel and the cover plate. In addition, the organic electro-luminance display panel has a plurality of first contacts and the cover plate has a control circuit and a plurality of second contacts, wherein the second contacts electrically connect with the first contacts for controlling the organic electro-luminance display panel via the control circuit.

The package of an organic electro-luminance display panel of the present invention further comprises a plurality of bumps for electrically connecting the first contacts and the second contacts. Additionally, the package of an organic electro-luminance display panel of the present invention further electrically connects the first contacts with the second contacts via, for example, a silver paste, an anisotropic conductive plate (ACP) or an anisotrpopic conductive film (ACF).

In the package of an organic electro-luminance display panel of the present invention, the frame is, for example, epoxy resin and has a double-layer structure, wherein the first sub-frame surrounds the second sub-frame and the second sub-frame is comprised of a moisture-absorption material for absorbing moisture therein.

In accordance with the objects described above, the present invention further discloses a method of forming a package of an organic electro-luminance display panel. The method comprises: providing an organic electro-luminance display panel having a plurality of first contacts; disposing a cover plate above the organic electro-luminance display panel, wherein the cover plate having a control circuit and a plurality of second contacts, and the second contacts are electrically connected to the first contacts for controlling the organic electro-luminance display panel via the control circuit; and forming a frame between the organic electro-luminance display panel and the cover plate.

The method of forming a package of an organic electro-luminance display panel of the present invention further comprises forming a plurality of bumps on the first contacts or the second contacts for electrically connecting the first contacts with the second contacts.

The method of forming a package of an organic electro-luminance display panel of the present invention further comprises forming a silver paste between the first contacts and the second contacts for electrically connecting the first contacts and the second contacts.

The method of forming a package of an organic electro-luminance display panel of the present invention further comprises forming an ACP between the first contacts and the second contacts for electrically connecting the first contacts and the second contacts.

The method of forming a package of an organic electro-luminance display panel of the present invention further comprises forming an ACF between the first contacts and the second contacts for electrically connecting the first contacts and the second contacts.

In accordance with the objects described above, the package of an organic electro-luminance display panel and the manufacturing method thereof integrate the control circuit on the cover plate for increasing the display area of the organic electro-luminance display panel. Compared with the prior art technology, the package of an organic electro-luminance display panel and the method thereof do not need additional circuit boards for carrying the driving devices so that the manufacturing cost is reduced. Additionally, because of the increase of the display area of the organic electro-luminance display panel, the resolution of the organic electro-luminance display panel is improved and better performance is achieved.

In order to make the aforementioned objectives and other objectives, features and advantages of the present invention understandable, a preferred embodiment accompanied with figures is described in detail below.

### BRIEF DESCRIPTION OF DRAWINGS

FIG. 1 is a schematic drawing showing a prior art package of an organic electro-luminance display panel.

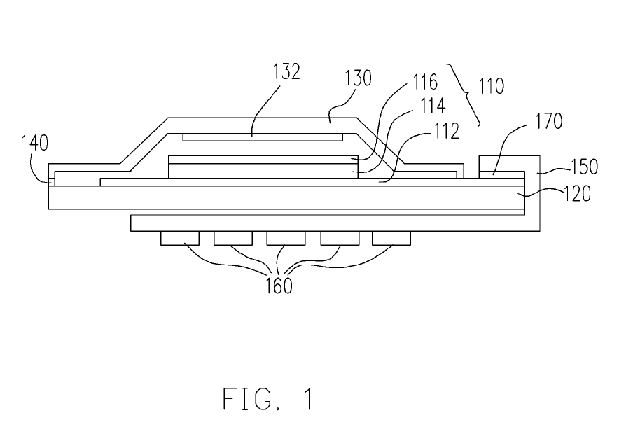

FIG. 2A is a schematic process flow showing a method of forming a package of an organic electro-luminance display panel according to a preferred embodiment of the present invention.

FIG. 2B is a schematic process flow showing a method of forming a package of an organic electro-luminance display panel according to another preferred embodiment of the present invention.

FIG. 3 is a schematic drawing showing a preferred package of the organic electro-luminance display panel in accordance with the present invention.

### DETAILED DESCRIPTION

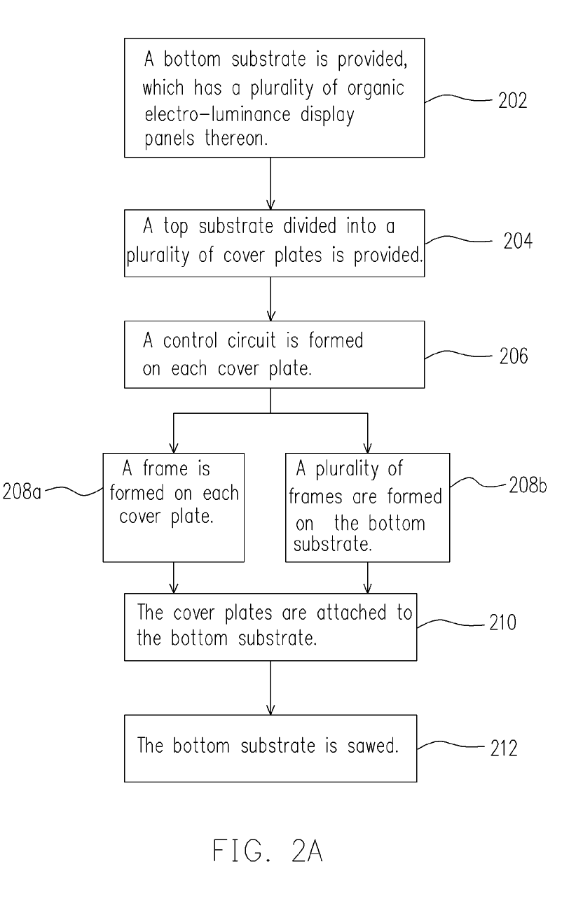

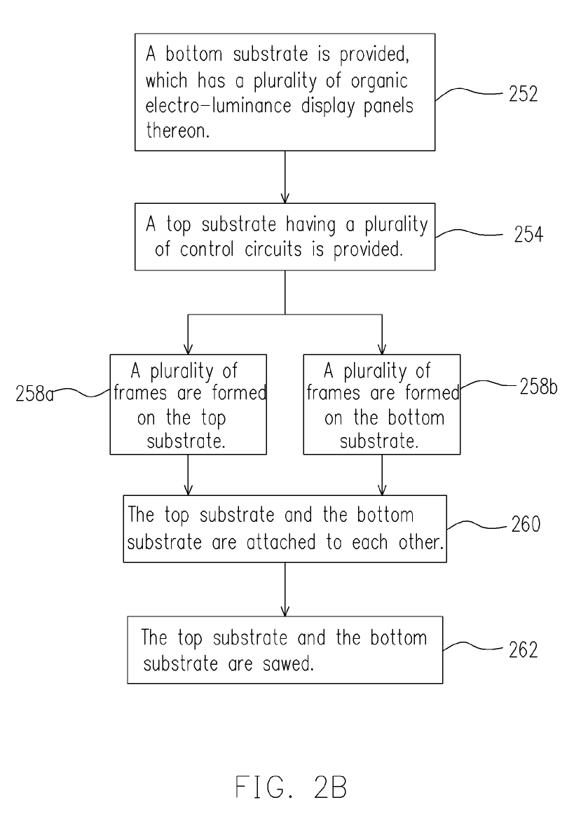

Referring to FIG. 2A, a schematic process flow showing a method of forming a package of an organic electro-luminance display panel is shown. First, a bottom substrate is provided, which has a plurality of organic electro-luminance display panels thereon (step 202) and a top substrate divided into a plurality of cover plates is provided (step 204). A control circuit is formed on each cover plate (step 206). A frame is formed on each cover plate (step 208a), or a plurality of frames is formed on the bottom substrate (step 208b). Finally, the cover plates are attached to the bottom substrate (step 210) and the bottom substrate is then sawed (step 212) and thus completing the manufacturing of the package of the organic electro-luminance display panel of the present invention. It should be noted that a plurality of second contacts which are electrically connected with the control circuit, for example, are formed when the control circuit is formed on the top substrate. And the bottom substrate further comprises, for example, a plurality of first contacts that are electrically connected with the organic electro-luminance display panel.

Referring to FIG. 2A, each cover plate is disposed over the organic electro-luminance display panel on the bottom substrate for connecting the organic electro-luminance display panel and cover plate by the frame. And each of the second contacts of the cover plate are electrically connected to one of the first contacts of the organic electro-luminance display panel respectively. Therefore, the control circuit can control the organic electro-luminance display panel. It should be noted that the first contacts and the second contacts connect to each other by different methods. For example, a plurality of bumps is selectively formed on the first contacts or the second contacts for electrically connecting thereto. The connection of the cover plate and the organic electro-luminance display panel can also be performed via, for example, silver paste, ACP or ACF for electrically connecting thereto. Furthermore, after the attachment of the cover plate and the organic electro-luminance display panel, an ultraviolet curing process can be performed for hardening the frame. If silver paste serves for electrically connecting the first contacts and the second contacts, an UV curing or thermal curing process can be performed to further enhance the connection of the first contacts and the second contacts. Additionally, the bottom substrate having organic electro-luminance display panels is sawed for forming a plurality of packages of organic electro-luminance display panels.

In addition to the first method of forming the package of the organic electro-luminance display panel, the present invention provides another method of forming the package of the organic electro-luminance display panel. Referring to FIG. 2B, a schematic process flow showing another preferred method of forming a package of an organic electro-luminance display panel. Some of the steps in the second method are similar to those of the first method, and therefore the descriptions for these steps are omitted. In step 252, a bottom substrate is provided, which has a plurality of organic electro-luminance display panels thereon. And a top substrate having a plurality of control circuits is provided in step 254. Then, a plurality of frames is formed on the top substrate in step 258a, or a plurality of frames is formed on the bottom substrate in step 258b. The top substrate and the bottom substrate are attached to each other in step 260, then the top substrate and the bottom substrate are sawed in step 262. The second method of forming the package of the organic electro-luminance display panel is completed. The difference between the first and the second methods is that the latter forms control circuits on the top substrate and the sawing of the top and bottom substrates after the attachment thereof. The second method can be applied to a large-size process, such as printing. A plurality of control circuits can be formed on the top substrate in one process to reduce the process time. Additionally, the better alignment between the cover plate and the organic electro-luminance display panel is also provided.

The package of the organic electro-luminance display panel manufactured by using method of forming the package of the organic electro-luminance display panel described above will now be described below.

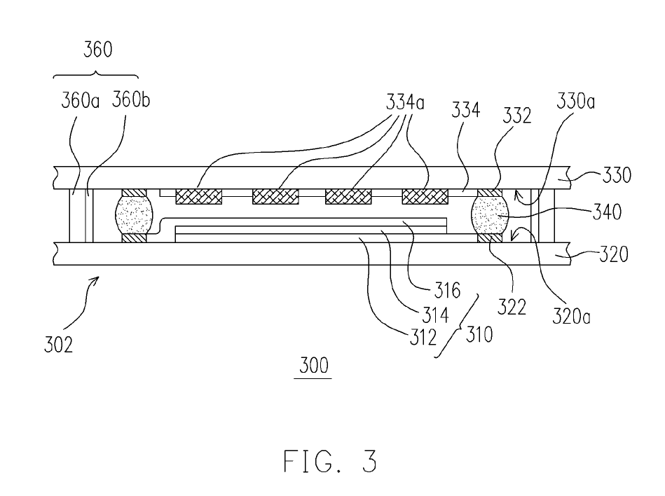

Referring to FIG. 3, a schematic drawing showing a preferred package of the organic electro-luminance display panel in accordance with the present invention is shown. The package of the organic electro-luminance display panel comprises, for example, an organic electro-luminance display panel 302, a cover plate 330 and a frame 360. The organic electro-luminance display panel 302 has a carrier substrate 320 and an organic electro-luminance device 310. The carrier substrate 320 has a carrier surface 320a and a plurality of first contacts 322 are disposed surrounding the carrier surface 320a. In addition, the organic electro-luminance device 310 comprises, for example, an anode layer 312, functional organic layer 314 and a cathode layer 316, wherein the anode layer 312 is formed on the carrier surface 320a of the carrier substrate 320. The material of the anode layer 312 and the cathode layer 316 can be, for example, indium tin oxide (ITO) or any other metal electrode. The organic functional layer 314 is formed on the anode layer 312 and the cathode layer 316 is formed on the organic functional layer 314. The anode layer 312 and the cathode layer 314 electrically connect with the first contacts 322.

Referring to FIG. 3, the cover plate 330 is disposed on the organic electro-luminance display panel 302 and has a connecting surface 330a corresponding to the carrier surface 320a. A plurality of second contacts 332 surrounds the connecting surface 330a and electrically connects with the first contacts 322 of the carrier substrate 320 via bumps 340. In addition, the connecting surface 330a of the cover plate 330 further comprises a control circuit 334, which comprises a plurality of driving devices 334a for controlling the organic electro-luminance device 310 via the first contacts 322 and the second contacts 332. It should be noted that in the method of forming the driving devices 334a, such as thin film transistors, printing or photolithographic and etch process are further performed on amorphous silicon(α-Si), LPTS or organic material. The bumps 340, the first contacts 322 and the second contacts 332 can be connect to each other via, for example, silver paste, ACP or ACF.

Referring to FIG. 3, the frame 360 is formed between the cover plate 330 and the organic electro-luminance display panel 302, and the frame 360 surrounds the control circuit 334, the first contacts 322, the second contacts 332 and the organic electro-luminance device 310. Furthermore, the frame 360 comprises, for example, a first sub-frame 360a and a second sub-frame 360b, wherein the first sub-frame 360a surrounds the second sub-frame 360b. The first sub-frame 360a can be, for example, epoxy resin, and the second sub-frame 360b can be, for example, moisture-absorption material for absorbing moisture within the package of the organic electro-luminance display panel 300 and maintaining the normal operation of the organic electro-luminance device 310.

Accordingly, the package of an organic electro-luminance display panel and the manufacturing method thereof integrate the control circuit on the cover plate for increasing the display area of the organic electro-luminance display panel. Compared with the prior art technology, the package of an organic electro-luminance display panel and the manufacturing method thereof do not need additional circuit boards for driving devices so that the manufacturing cost is reduced. Additionally, because of the increase of the display area of the organic electro-luminance display panel, the resolution of the organic electro-luminance display panel is improved and better performance is achieved. Additionally, the frame of the package of an organic electro-luminance display panel can be a moisture-absorption material for absorbing moisture within the package of the organic electro-luminance display panel, maintaining the normal operation of the organic electro-luminance device and extending the service life thereof.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A package of an organic electro-luminance display panel, comprising:
an organic electro-luminance display panel, having a plurality of first contacts;
a cover plate, on the organic electro-luminance display panel, having a control circuit and a plurality of second contacts, wherein the second contacts are electrically connected with the first contacts for controlling the organic electro-luminance display panel via the control circuit; and
a frame, connecting between the organic electro-luminance display panel and the cover plate.

2. The package of an organic electro-luminance display panel of claim 1, further comprising a plurality of bumps electrically connecting the first contacts and the second contacts.

3. The package of an organic electro-luminance display panel of claim 1, further comprising a silver paste electrically connecting the first contacts and the second contacts.

4. The package of an organic electro-luminance display panel of claim 1, further comprising an ACP electrically connecting the first contacts and the second contacts.

5. The package of an organic electro-luminance display panel of claim 1, further comprising an ACF electrically connecting the first contacts and the second contacts.

6. The package of an organic electro-luminance display panel of claim 1, wherein the frame is comprised of an epoxy resin.

7. The package of an organic electro-luminance display panel of claim 1, wherein the frame comprises a first sub-frame and a second sub-frame, the first sub-frame surrounds the second sub-frame and the second frame is moisture-absorption material.

8. A method of forming a package of an organic electro-luminance display panel, comprising:
providing an organic electro-luminance display panel having a plurality of first contacts;
disposing a cover plate on the organic electro-luminance display panel, wherein the cover plate has a control circuit and a plurality of second contacts, and the second contacts electrically connect with the first contacts for controlling the organic electro-luminance display panel via the control circuit; and
forming a frame between the organic electro-luminance display panel and the cover plate.

9. The method of forming a package of an organic electro-luminance display panel of claim 8, further comprising the step of forming a plurality of bumps on the first contacts.

10. The method of forming a package of an organic electro-luminance display panel of claim 8, further comprising the step of forming a plurality of bumps on the second contacts.

11. The method of forming a package of an organic electro-luminance display panel of claim 8, further comprising the step of forming a silver paste for electrically connecting the first contacts and the second contacts.

12. The method of forming a package of an organic electro-luminance display panel of claim 8, further comprising the step of forming an ACP for electrically connecting the first contacts and the second contacts.

13. The method of forming a package of an organic electro-luminance display panel of claim 8, further comprising the step of forming an ACF for electrically connecting the first contacts and the second contacts.
